(19) United States
(12) Patent Application Publication
(10) Pub. No.: US 2006/0262779 A1
(43) Pub. Date: Nov. 23, 2006

(54) A METHOD AND APPARATUS FOR TRANSFERRING DATA BETWEEN CORES IN AN INTEGRATED CIRCUIT

(75) Inventors: Adam J. Courchesne, Jericho, VT (US); Kenneth J. Goodnow, Essex Junction, VT (US); W. Riyon Harding, Richmond, VT (US); David W. Milton, Underhill, VT (US); Jason M. Norman, Essex Junction, VT (US); Clarence R. Ogilvie, Huntington, VT (US); Jason E. Rotella, Mineville, NY (US); Paul M. Schanely, Essex Junction, VT (US); Sebastian T. Ventrone, South Burlington, VT (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 10/908,597

(22) Filed: May 18, 2005

(51) Int. Cl. H04L 12/50

(52) U.S. Cl. 370/360

(57) ABSTRACT

A method and apparatus for providing communication between various cores located in an integrated circuit. The method and apparatus uses Hubs/Routers to facilitate and manage communication of data from/between the cores according to a specified methodology.

### BACKGROUND

1. Technical Field of the Present Invention

The present invention generally relates to integrated circuits, and more specifically, to methods and apparatuses that facilitate the transfer of data between the various cores located within the integrated circuit.

2. Description of Related Art

Technological advancements in semiconductors have resulted in consumers expecting increasingly smaller more powerful devices. The number of circuits/functional units (cores) that reside on a typical integrated circuit to support these functions is astronomical. The sheer number of devices has forced the semiconductor industry to solve new problems associated with power consumption, heat dissipation, noise, and communication. A related issue is the number of wires required to provide communication between the various cores that implement the desired functionality. In the past, the wiring of the communication from one core to another has been accomplished using point-to-point techniques. Unfortunately, the exponential increase in density is causing point-to-point wiring to reach its limits.

It would, therefore, be a distinct advantage to have a method and apparatus that could transfer data from one core to another while addressing the concerns that arise during dense point-to-point wiring. The present invention provides such a method and apparatus.

### SUMMARY OF THE PRESENT INVENTION

The present invention is a method and apparatus for providing communication between various cores located in an integrated circuit. More specifically, the present invention uses Hubs/Routers to facilitate and manage communication of data from/between the cores according to a specified methodology.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram illustrating an example of a hub/router network for transferring data between various cores residing in an integrated circuit according to the teachings of the present invention;

FIG. 2 is a schematic diagram is shown illustrating in greater detail one of the hubs of FIG. 1 according to the teachings of the preferred embodiment of the present invention;

FIG. 3 is a flow chart illustrating the method used by the Hubs of FIG. 1 for receiving data from adjacent Hubs and Cores according to the teachings of the present invention; and

FIG. 4, a flow chart is shown illustrating the steps used by the Hubs 6-10 for transmitting previously received data according to the teachings of the present invention.

### DETAILED DESCRIPTION OF THE PREFERRED EMBODIMENT OF THE PRESENT INVENTION

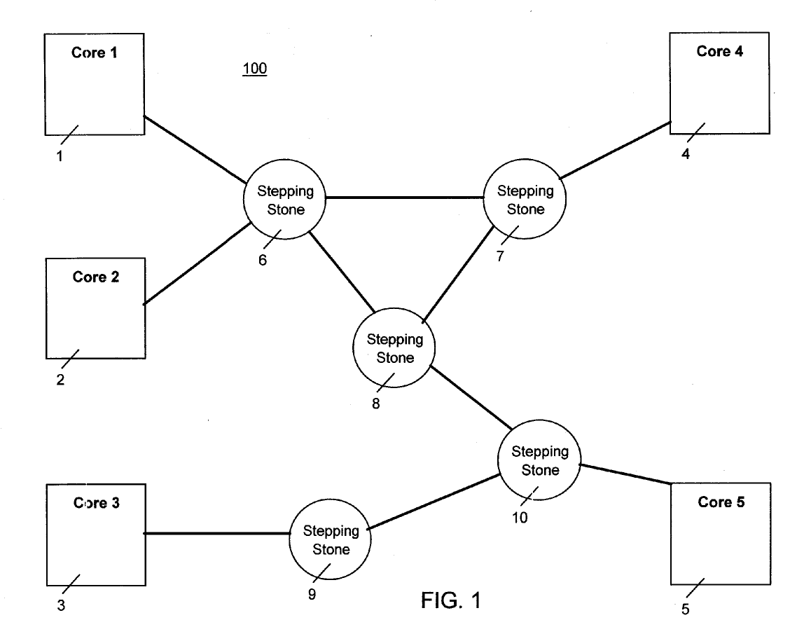

The present invention is a system and method for transferring data between various cores residing in an integrated circuit. The system/method uses hub/routers that are strategically located between the various cores. The operation of the hub/routers for providing the communication is explained in greater detail in connection with FIG. 1.

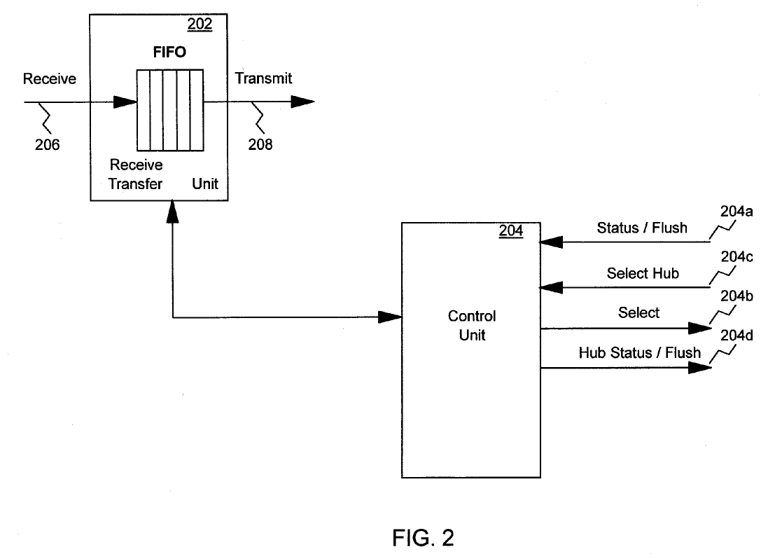

Reference now being made to FIG. 1, a block diagram is shown illustrating an example of a Hub network 100 for transferring data between various Cores 1-5 residing in an integrated circuit 20 according to the teachings of the present invention. In this particular example, the Hub network 100 includes four Hubs 6-10 which are connected one to another so as to provide a communication path between Cores 1-5 in accordance with a particular design. In a preferred embodiment of the present invention, a Hub is initially placed within a distance of one clock cycle of a Core (e.g. Hubs 6-7 and 9-10 for cores 1 and 4, and 3 and 5, respectively). In an alternative preferred embodiment, the Hubs operate at a multiple of the frequency of the Cores 1-5. Regardless of how the frequency is selected for the operation of the Hubs 6-7, it should be sufficient so as to meet the timing requirements of the Cores 1-5. It should also be noted that the number of Hubs required to sufficiently transfer data among various Cores is dependent upon the distance between the Cores, desired number of redundant paths, and overall system design. As such, this particular example is used for ease of explanation and is not to be considered a limitation on the arrangement or number of cores that can be supported in a particular system implementation. The components of the Hubs 6-10 involved with providing communication are explained in greater detail in connection with FIG. 2.

Reference now being made to FIG. 2, a schematic diagram is shown illustrating in greater detail Hub 6 of FIG. 1 according to the teachings of the preferred embodiment of the present invention. Hub 6 is representative of a Hubs 7-10, and therefore, the discussion provided therewith is equally applicable to Hubs 7-10. Hub 6 includes a Receive/Transmit Unit 202 and a Control Unit 204.

The Receive/Transmit Unit 202 is responsible for receiving, storing, and transmitting data to/from other adjacent Hubs 7-10 or adjacent Cores 1-5. The Receive/Transmit unit 202 receives data on Receive communication line 206, and transmits data on Transmit communication line 208. The Receive/Transmit unit 202 includes a FIFO (First In First Out memory mechanism) for storing received data via the Receive communication line 206, and temporarily storing data for transmission on the Transmit communication line 208. For purposes of clarity, the Receive and Transmit communication lines 206 and 208, respectively are illustrated as being separate one from another. It should be noted, however, that these communication lines 206-208 can be implemented using a tagging scheme and shared bus or the like. The Control Unit 204 manages the receipt and transmission of data by the Receive/Transmit Unit 202 as explained below.

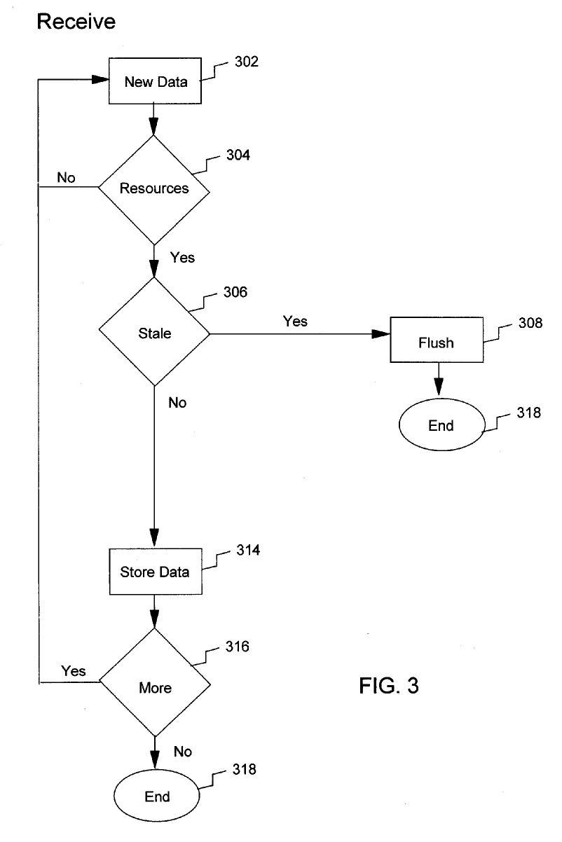

Control Unit 204 receives and transmits various signals to and from other adjacent Hubs (7-8) and Cores 1-2. The receipt and transmission of these signals by the Control Unit 204 can be accomplished using individual communication lines for each of the signals as well as a tagging methodology in combination with a desired bus type structure. For each of the adjacent hubs (7-8) and adjacent Cores (1-2), Control Unit 204 receives a Status/Flush signal 204a and a Select Hub signal 204c, and transmits a Select signal 204b and a Hub Status/Flush signal 204d. The interaction between the various signals, the Control Unit 204, and the Receive/Transmit Unit 202 is explained in connection with FIG. 3.

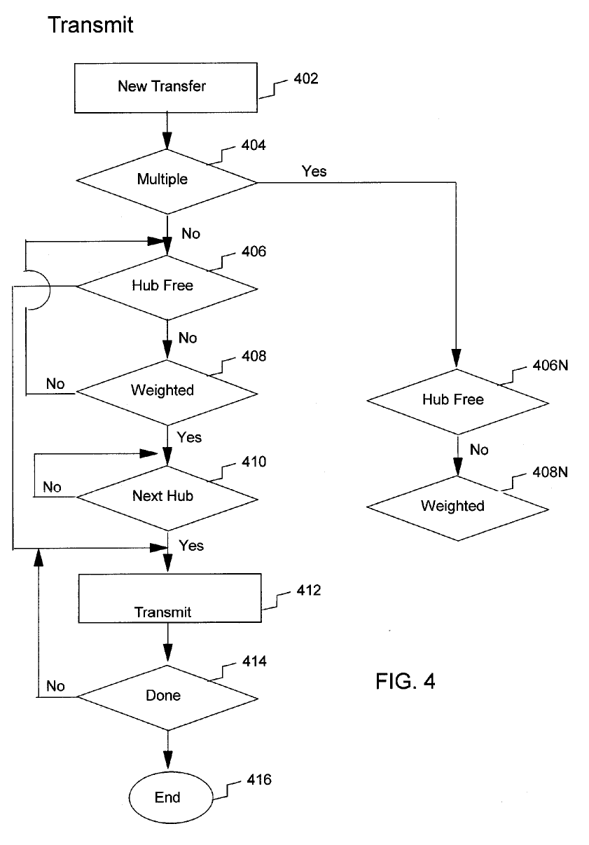

Reference now being made to FIG. 3, a flow chart is shown illustrating the method used by the Hubs 6-10 for receiving data from adjacent Hubs 6-10 and Cores 1-5 according to the teachings of the present invention. For ease of explanation and clarity, Hub 6 (FIG. 2) is used as an example of how the method is implemented in each of the Hubs 7-10. Prior to receiving any data, Hub 6 via the Control Unit 204 receives a Select Hub signal 204c from one of the adjacent Hubs (7-8) or Cores (1-2) (Step 302). In response to the Select Hub signal 204c, the Control Unit 204 communicates with the Receive/Transmit Unit 202 to verify that the FIFO has sufficient resources (e.g. memory) to receive the requested data (Step 304). If the FIFO does not have sufficient resources to receive and process the requested data, then the Control Unit 204 sends an indication that Hub 6 is currently busy via Hub Status/Flush signal 204d to the requesting adjacent Hub 7-8 (step 304) or Core (1-2) (Step 304) (The processing of the busy signal is explained in connection with the transmission of data by a Hub (i.e. FIG. 4)). If, however, the FIFO has sufficient resources to receive and process the requested data, then the Control Unit 204 sends an indication that Hub 6 can receive the requested data via Hub Status/Flush signal 204d. The adjacent Hub (7-8) or Core (1-2) then beings to transfer the data according to the process described in connection with FIG. 4.

It should be noted that in the preferred embodiment of the present invention, multiple Hubs can be used to simultaneously transmit the same data (e.g. when receipt of the data by one of the Cores 1-5 is critical). In general, the transmission of the data is accomplished using packets or other similar type data structure for segmenting data into components that can be transferred individually and reassembled upon their receipt. Consequently, when there are multiple transmissions of the same data, the destination Core 1-5 needs to be able to distinguish between different sets of the same data and when to discard stale data. The present invention accomplishes this requirement by using unique identifiers to identify a particular set of data and affixes a time stamp to each packet (e.g. in the header) of data according to the time at which it was received by each preceding Hub 6-10. In the scenario where multiple sets of data are on route to a destination Core 1-5, the destination Core 1-5 examines the first packet it receives, records the unique identifier and time stamp. Any subsequently received duplicate sets of the same data (those packets having a unique identifier that is different from that of the first received packet) are ignored and a flush signal is sent to the transmitting Hub 6-10. The processing of the Flush signal is explained below.

If a flush signal has been previously received either from an adjacent Hub (6-10) or Core (1-5), then the Control Unit 204 compares the unique identifier in the first packet that is received (Step 306), and if it matches that of the identifier in the flush signal, then a Flush signal is sent to the adjacent Hub 7-8 that is transmitting the data and any new data received having the flush identifier is ignored (Step 308). The processing of the receipt of a flush signal is explained in connection with the description of FIG. 4 for the transmission of data by a Hub 6-10.

If, however, the identifier in the first received packet does not match that of a flush identifier, then the data/packet is stored in the FIFO (Step 314). If the Hub 6 is still selected via Select Hub signal 204c (i.e. More data needs to be received), the processing proceeds to Step 302 and repeats the method from that point (Step 316). If, however, the Hub 6 is not selected, then the processing ends until the Hub 6 is selected again (step 318).

Reference now being made to FIG. 4, a flow chart is shown illustrating the steps used by the Hubs 6-10 for transmitting previously received data according to the teachings of the present invention. If there is data residing in the FIFO (step 402), then the processing of that data by the Control Unit 204 begins by examining the data to determine if it includes a prioritization scheme indicator. The prioritization scheme indicator can be, for example, an indication in the header of the packet to rank the priority of the data for processing. More specifically, the priority can be ranked and depending upon the a specified rank, the Hub 6-10 has the ability to transmit multiple copies of the same data to ensure that the data reaches the destination Core 1-5 in the most expedient manner. In the preferred embodiment of the present invention, when the data has a prioritization scheme of a predefined rank/level, the transmitting Hub 6-10 will transmit multiple copies to all or some of the adjacent Hubs 6-10 depending upon the particular design implementation (Step 404).

The Control Unit 204 selects either a single or multiple adjacent Hubs 6-10 for receipt of the data via the Select signal 204b (the signal being transmitted to each adjacent Hub 6-10 (Step 406-406n). The selection of either single or multiple adjacent Hubs 6-10 can also be based upon a weighted determination. For example, the first attempt of the transmission of the data would be to a first preferred adjacent Hub 6-10. If the preferred adjacent Hub 6-10 was busy, then an attempt to transmit the data to next preferred adjacent Hub 6-10 could occur and so on.

Upon receiving a Status/Flush signal 204a from one or more adjacent Hubs 6-10 or Cores 1-5, the Control Unit 204 examines the Status/Flush signal 204a to determine if the selected adjacent Hub 6-10 is available. If the Status/Flush signal 204a indicates that the selected adjacent Hub 6-10 is currently unavailable (step 408), depending on the particular scheme employed the Control Unit 204 with either wait a predetermined period of time and then try again to select the adjacent Hub 6-10 via Select signal 204b, or try the next weighted adjacent Hub 6-10 again using Select signal 204b (Steps 410). The attempt to use the next weighted Hub 6-10 can either proceed down a vertical path (illustrated) where each weighted Hub 6-10 is attempted one after another or in a horizontal (parallel) fashion similar to that used for step 406 for launching multiple sets of the same data (not illustrated).

If the Control Unit 204 receives an indication that the selected adjacent Hub 6-10 is available

If the Control Unit 204 receives an indication that the selected adjacent Hub 6-10 is available (step 412), then the Control Unit 204 transmits the data (in packets or the like) to the adjacent Hub 6-10 or Core 1-5 via Transmission line 208. After transmitting a packet, the Control Unit 204 determines whether there is additional related data to be transferred to the adjacent Hub 6-10 or Core 1-2 (Step 414).

At this time, it is also possible that the Control Unit 204 could receive a flush indication via the Status/Flush signal 204a from the adjacent Hub 6-10 or Core 1-5. The flush signal would include an indicator sufficient to coincide with the indicator used to identify the particular instance/set of data being transmitted as previously explained.

If a Flush signal was received, then the Control Unit 204 flushes the data identified in the flush signal that is still pending in the FIFO. In addition, the flush identifier is saved for a predetermined period of time so that if any preceding Hubs 6-10 transmit additional pieces of the now identified stale data (step 414). If there is either no more related data to be transmitted or the processing of the flush signal is complete, then the process proceeds to end at step 416.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. An integrated circuit comprising:
a plurality of cores each one capable of implementing a desired function;
a plurality of hubs each one capable of receiving and transmitting data from one the cores initiating a data transfer to a destination at another one of the cores.

2. The integrated circuit of claim 1 wherein the plurality of hubs includes:
a first set of hubs each one being associated with at least one of the cores each one of the first hubs capable of receiving and transmitting data to and from it's associated core.

3. The integrated circuit of claim 2 wherein the plurality of hubs includes:
a second set of hubs each one being associated with at least one of the first set of hubs, each one of the second hubs capable of receiving and transmitting data to and from it's associated first hub(s).

4. The integrated circuit of claim 3 wherein the plurality of hubs includes:
a third set of hubs each one being associated with at least one of the second hubs, each one of the third hubs capable of receiving and transmitting data to and from it's associated second hub.

5. The integrated circuit of claim 4 wherein each one of the first, second and third hubs includes:
a receive/transfer unit capable of receiving and transferring data; and
a control unit capable of controlling the receipt and transfer of data via the receive/transfer unit, and of receiving and transmitting various signals for maintaining data integrity.

6. The integrated circuit of claim 5 wherein the receive/transfer unit includes a FIFO for storing and transmitting data.

7. The integrated circuit of claim 6 wherein the control unit includes:
a signal for indicating whether one of the hubs to which data is to be transferred is available.

8. The integrated circuit of claim 6 wherein the control unit includes:
a signal for indicating whether one of the cores to which data is to be transferred.

9. The integrated circuit of claim 6 wherein the control unit is capable of transmitting a signal indicating the availability of the resources of the hub to which data is to be transferred.

10. The integrated circuit of claim 6 wherein the control unit includes:
logic for transmitting multiple copies of the same data to differing hubs.

11. An integrated circuit comprising:
two or more cores of functional logic; and
two or more local receive/transmit units each of which are adjacent with at least one of the cores, the adjacent receive/transmit units being capable of simultaneously receiving and transmitting data to/from one or more of the cores.

12. The integrated circuit of claim 11 further comprising:
two or more intermediate receive/transmit units each of which are adjacent with at least one of the local receive/transmit units, the intermediate receive/transmit units being capable of simultaneously receiving and transmitting data to/from one or more of the cores.

13. The integrated circuit of claim 12 wherein one or more of the local adjacent receive/transmit units includes:
logic capable of transmitting multiple copies of the same data to differing adjacent intermediate receive/transmit units.

14. The integrated circuit of claim 13 wherein one or more of the local adjacent receive/transmit units includes:
logic capable of receiving a stale signal from one of the cores indicating that a copy of the data attempting to be transmitted to the core has already been received.

15. The integrated circuit of claim 14 wherein one or more of the local adjacent receive/transmit units includes:
logic capable of deleting the data to be transferred to the core in response to receiving the stale signal.

16. The integrated circuit of claim 13 wherein one or more of the local adjacent receive/transmit units includes:
logic for receiving and storing data from the one or more adjacent intermediate receive/transfer units.

17. The integrated circuit of claim 16 wherein one or more of the local adjacent receive/transmit units includes:
logic for indicating to an adjacent intermediate receive/transfer attempting to transfer data to the local adjacent receive/transmit unit that the data is stale.

18. The integrated circuit of claim 17 wherein one or more of the intermediate adjacent receive/transmit units includes:
logic capable of deleting, in response to the stale indication, any of the associated stale data.

19. The integrated circuit of claim 18 wherein each one of the local receive/transmit units includes:
logic capable of receiving and storing data from the one or more adjacent cores.

20. The integrated circuit of claim 19 wherein each one of the intermediate receive/transmit units includes:
logic capable of receiving and storing data from one or more of the adjacent local receive/transmit units.
